(19) United States
(12) Patent Application Publication
(10) Pub. No.: US 2013/0316233 A1
(43) Pub. Date: Nov. 28, 2013

(54) PARTICULATE MIXTURE, CATHODE ACTIVE MATERIAL, CATHODE, SECONDARY BATTERY, AND PRODUCTION METHOD THEREOF

(71) Applicant: FURUKAWA ELECTRIC CO., LTD, Tokyo (JP)

(72) Inventors: Yosuke HIRAYAMA, Tokyo (JP); Michio OHKUBO, Tokyo (JP)

(73) Assignee: FURUKAWA ELECTRIC CO., LTD., Tokyo (JP)

(21) Appl. No.: 13/957,031

(22) Filed: Aug. 1, 2013

Related U.S. Application Data
(63) Continuation of application No. PCT/JP2012/052343, filed on Feb. 2, 2012.

(30) Foreign Application Priority Data
Feb. 2, 2011 (JP) 2011-020519

(51) Int. Cl. H01M 4/58

(52) U.S. Cl. CPC H01M 4/5825
USPC 429/211; 423/306; 427/126.1; 429/231.95; 429/221; 429/224; 429/231.5; 429/223; 429/220; 429/229; 429/231.8

(57) ABSTRACT

The object of the present invention is to provide a method for producing lithium transition metal phosphate with a small particle size and uniform element spatial distribution, which enables continuous and large-scale synthesis. Its solution is as follows: A particulate mixture is synthesized by the spray-combustion method, wherein a mixed solution containing a lithium source, a transition metal source, and a phosphorus source is supplied into a flame along with a combustion-supporting gas and a flammable gas, as a mist-like droplet. It is a method for producing lithium transition metal phosphate-type cathode active material, which further comprises a process of mixing the synthesized particulate mixture with a carbon source, a process of calcining the particulate mixture under inert gas atmosphere to produce an active material aggregate, and a process of pulverizing the active material aggregate.

### RELATED APPLICATIONS

The present application is a continuation of International Application Number PCT/JP2011/052343, filed Feb. 2, 2012, and claims priority from, Japanese Application Number 2011-020519, filed Feb. 2, 2011. The above listed applications are hereby incorporated by reference in their entirety.

### TECHNICAL FIELD

The present invention relates to a lithium transition metal phosphate-type cathode active material that can be used in non-aqueous electrolyte secondary batteries, and a particulate mixture, which is a precursor thereof.

### BACKGROUND ART

In recent years, with the mobilization and high functionality of electronic equipments, the secondary battery, which is a power source, has become one of the most important parts. In particular, lithium ion secondary battery has taken the position of mainstream in place of conventional NiCd battery and Ni-hydrogen battery, due to its high energy density obtained from the high voltage of the cathode active material and anode active material. However, Li-ion secondary battery by the combination of lithium cobalt oxide (LiCoO₂)-type cathode active material and carbon-type anode active material based mainly of graphite, which is currently used in Li-ion batteries as a standard, is incapable of sufficiently supplying the amount of electricity required for today's high-functionality high-intensity electronic parts, and is incapable of fulfilling the required performance of a portable power source.

Further, since lithium cobalt oxide utilizes cobalt, which is a rare-metal, it is largely restricted in terms of resource, is expensive, and is problematic in terms of price stability. Furthermore, since lithium cobalt oxide emits large amounts of oxygen at high temperatures above 180° C., there is a possibility of explosion in case of abnormal heat generation or short-circuiting of the battery.

Thus, lithium iron phosphate (LiFePO₄) and other lithium transition metal phosphates that comprise an olivine structure are receiving much attention as a material that can satisfy the resource, cost, and safety aspects.

As a method of synthesizing lithium iron phosphate, a method called a solid phase method is known. The solid phase method is basically a method wherein powders of a lithium source, an iron source, and a phosphorus source are mixed and subjected to calcination under inert atmosphere. This method can be problematic in that it requires careful selection of calcination condition, or else the composition of the product will not be as aimed, and that controlling of its particle size is difficult.

Further, as a method of synthesizing lithium iron phosphate, a method called the hydrothermal synthesis method, which utilizes hydrothermal synthesis in liquid phase, is also known. The hydrothermal synthesis method is performed under the presence of high-temperature high-pressure hot water. Products of high purity can be obtained at much lower temperatures compared to the solid phase method. However, in this method, the particulate size is controlled by various preparation conditions such as reaction temperature and time, but reproducibility of the particle size was low, and controlling of the particulate size was difficult. (For example, see Patent Document 1.)

Furthermore, as a method of synthesizing lithium iron phosphate, there is a spray thermal decomposition method. In the spray thermal decomposition method, a fine mist is formed from a mixed solution of carbon-containing compound, lithium-containing compound, iron-containing compound, and phosphorus-containing compound. A fine powder comprising a carbon-containing lithium iron phosphate precursor is then produced by circulating the fine mist and heating to undergo thermal decomposition. The precursor fine powder is further heated and calcined under inert gas-hydrogen gas mixed gas atmosphere, to produce a carbon-containing lithium iron phosphate powder. (See Patent Document 2.)

### PRIOR ART DOCUMENTS

### Patent Documents

[Patent Document 1] WO/2009/131095
[Patent Document 2] JP-A-2009-070666

### SUMMARY OF THE INVENTION

### Technical Problem

However, lithium iron phosphate is problematic in that it has a low electrical conductivity due to its structure, and is poor in lithium ion diffusibility, causing its charge-and-discharge rate to be low.

For this reason, lithium iron phosphate with a smaller particle size is in demand. If the particle size is small, the conductive path through lithium iron phosphate becomes short, even if the electrical conductivity of lithium iron phosphate itself is low. Further, it is believed that if the particle size is small, the diffusion distance becomes small, enabling it to respond to high-speed charge-and-discharge.

Furthermore, although in a layered structure as in LiCoO₂ or a spinel structure as in LiMnO₂, the direction of diffusion of lithium ion during charge-and-discharge is two-dimensional or three-dimensional, in an olivine structure as in lithium iron phosphate, the diffusion direction of lithium ion is one-dimensional. Thus, if the composition within the lithium iron phosphate particle is nonuniform, the diffusion of lithium ion is hindered, causing only part of the lithium iron phosphate composing the particle to be involved in charge-and-discharge, leading to the deterioration of capacity.

Moreover, both the solid phase method and the hydrothermal synthesis method are basically batch methods that utilize small-scale reactors, and a method that enables continuous large-scale synthesis of lithium iron phosphate was desired.

Furthermore, in the above-mentioned spray thermal decomposition method, the thermal decomposition temperature is 500 to 900° C. (Claim 2 of Patent Document 2), and a thermal decomposition time of over 10 seconds (calculated from paragraph 0026 of Patent Document 2) was required. Compared to the spray combustion method of present invention, in which temperature is high (1000 to 3000° C., usually around 2000° C.) and combustion time is short (several milliseconds), in the spray thermal decomposition method, the temperature was low and reaction rate slow. That is, since combustion is performed under high temperature in a short period of time in the spray combustion method of the present invention, the particle size of the particulate mixture (active material precursor) becomes small, and each particle exist independently. Further, in the aforementioned spray thermal decomposition method, the carrier gas consist only of inert gas, but in the spray combustion method of the present invention, the carrier gas of the mist contains a flammable gas and burns the droplet of the raw material solution.

Moreover, in the aforementioned spray thermal decomposition method, because carbon is incorporated in the thermal decomposition process, hydrogen gas as a reductive gas must be added in the calcination process. On the other hand, in the spray combustion method of the present invention, since the carbon source is added after the production process of the particulate by the spray combustion method, a reductive carbon can be utilized and a reductive gas is not necessary in the calcination process.

The present inventors discovered that by synthesizing lithium transition metal phosphate using the spray combustion method, a lithium transition metal phosphate with a small particle size and uniform element spatial distribution can be synthesized continuously in large scale.

### Means for Solving the Problem

The present invention was made in view of the above-described problems, and its object is to provide a method for producing lithium transition metal phosphate with a small particle size and uniform element spatial distribution, which enables continuous and large-scale synthesis.

Hence, the present invention provides the following inventions:

(1) A method for producing a particulate mixture, which comprises: supplying a mist-like droplet of a mixed solution containing a lithium source, a transition metal source, and a phosphorus source into a flame along with a combustion-supporting gas and a flammable gas to thereby synthesize a particulate mixture.
(2) The method for producing a particulate mixture according to (1), wherein a temperature of the flame is 1000 to 3000° C.
(3) The method for producing a particulate mixture according to (1), wherein the flammable gas is a hydrocarbon-type gas, and the combustion-supporting gas is air.
(4) The method for producing a particulate mixture according to (1), wherein a lithium compound of the lithium source is one or more of lithium chloride, lithium hydroxide, lithium acetate, lithium nitrate, lithium bromide, lithium phosphate, lithium sulfate, lithium oxalate, lithium naphthenate, lithium ethoxide, lithium oxide, and lithium peroxide; a transition metal compound of the transition metal source is one or more of a chloride, oxalate, acetate, sulfate, nitrate, hydroxide, ethyl hexanoate, naphthenate, salt of hexoate, cyclopentadienyl compound, alkoxide, organic acid metal salt (salts of stearic acid, dimethyl dithiocarbamic acid, acetyl acetonate, oleaic acid, linoleic acid, linolenic acid), or oxide of at least one transition metal selected from a group consisting of Fe, Mn, Ti, Cr, V, Ni, Co, Cu, Zn, Al, Ge, Zr, Mo, and W; and a phosphorus compound of the phosphorus source is one or more of phosphonic acid, orthophosphoric acid, methaphosphoric acid, pyrophosphoric acid, diammonium hydrogen phosphate, ammonium dihydrogen phosphate, ammonium phosphate, sodium phosphate, and ferrous phosphate.
(5) A method for producing a lithium transition metal phosphate-type cathode active material, which comprises: a process of mixing the particulate mixture produced by the method of producing a particulate mixture according to (1) with a carbon source; and a process of calcining the particulate mixture mixed with the carbon source under inert gas atmosphere to thereby produce an active material aggregate.
(6) The method for producing a lithium transition metal phosphate-type cathode active material according to (5), which further comprises a process of pulverizing the active material aggregate.
(7) The method for producing a cathode active material according to (5), wherein the carbon source is one or more of poly vinyl alcohol, sucrose, and carbon black.
(8) The method for producing a cathode active material according to (5), wherein the calcining is performed by heat treatment under inert gas atmosphere for 0.5 to 10 hours at 300 to 900° C.
(9) A method for producing a cathode for non-aqueous electrolyte secondary battery, which comprises: a process of mixing a cathode active material produced by the method for producing a cathode active material according to (5) with at least a binding agent and a solvent to thereby prepare a slurry; and a process of applying the slurry on to a current collector and calcining.
(10) The method for producing a cathode for non-aqueous electrolyte secondary battery according to (9), wherein the slurry contains a secondary particle with a size of 0.5 to 20 μm obtained by granulating the cathode active material produced by the method for producing a cathode active material according to (5).
(11) A particulate mixture, in which the configuration of a primary particle is approximately spherical; a particle size of the primary particle is in a range of 5 nm to 200 nm; and which comprises a particle containing phosphorus, transition metal, and lithium.
(12) The particulate mixture according to (11), wherein the particulate is amorphous; and the particulate contains an oxide of the transition metal.
(13) The particulate mixture according to (11), wherein an element spatial distribution within the particulate is uniform.
(14) A cathode active material, which is obtained by calcining the particulate mixture according to (11), wherein the configuration of the primary particle is approximately spherical; the particle size of the primary particle is in a range of 10 nm to 200 nm; and which contains a lithium transition metal phosphate particulate.
(15) The cathode active material according to (14), which is obtained by mixing the particulate mixture according to (11) with a carbon source and subsequently calcining, wherein the lithium transition metal phosphate particulate is at least partly carbon-coated or at least partly carbon-supported.
(16) The cathode active material according to (14), wherein the transition metal in the lithium transition metal phosphate contains at least one element of Fe, Mn, Ti, Cr, V, Ni, Co, Cu, Zn, Al, Ge, Zr, Mo, and W.
(17) A cathode for non-aqueous electrolyte secondary battery, which comprises: a current collector, and a cathode active material layer containing the cathode active material according to (14) on at least one side of the current collector.
(18) A non-aqueous electrolyte secondary battery, which comprises: the cathode for non-aqueous electrolyte secondary battery according to (17); an anode that is able to occlude and discharge lithium ion; and a separator arranged between the cathode and the anode, wherein the cathode, the anode and the separator are provided in an electrolyte that shows lithium ion conductivity.

### Effect of the Invention

The present invention provides a method for producing lithium transition metal phosphate with a small particle size and uniform element spatial distribution, which enables continuous and large-scale synthesis.

### BRIEF DESCRIPTION OF THE DRAWINGS

FIG. 1: a schematic diagram that shows the particulate production apparatus used in the spray-combustion method for producing the particulate mixture of the present invention.

FIG. 2: a schematic sectional diagram that shows the non-aqueous electrolyte secondary battery that utilizes the cathode active material of the present invention.

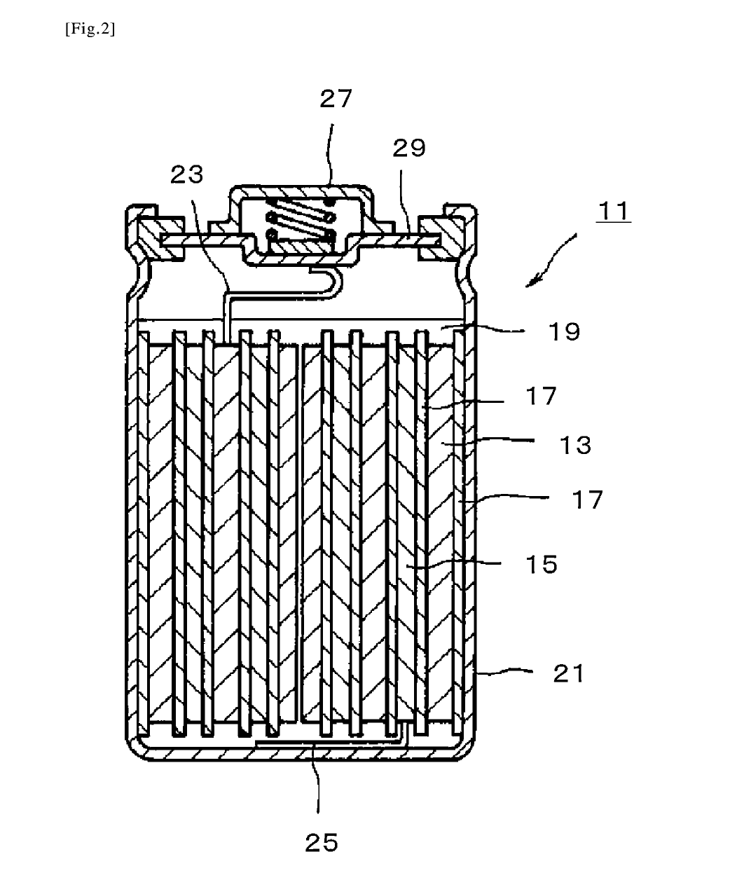

FIG. 3: (a) the particulate mixture of Example 1; (b) the XRD measurement result for the cathode active material.

FIG. 4: (a) a transmission electron microscope (TEM) image of the particulate mixture of Example 1 prior to calcination; (b) a TEM image of the cathode active material of Example 1 after calcination.

FIG. 5: (a) A HAADF-STEM image of the particulate mixture of Example 1; (b) an EDS map for iron atom from the same observation point; (c) an EDS map for phosphorus atom from the same observation point; (d) an EDS map for oxygen atom from the same observation point.

FIG. 6: the charge-and-discharge curves for the first cycle of the non-aqueous electrolyte secondary battery of (a) Example 1 that utilizes the spray combustion method (solid line) and (b) Comparative Example 1 that utilizes the solid phase method (broken line).

### BEST MODE FOR CARRYING OUT THE INVENTION

Hereinafter, favorable embodiments of the particulate mixture and the cathode active material etc. of the present invention will be described. Note that the present invention is not limited to these embodiments.

The cathode active material of the present invention is obtained and provided as a powdery material. Further, the cathode active material may be provided as it is, or may be provided as a slurry of aqueous solvent or organic solvent, by subjecting to a granulation process to increase its sizes and prepare a secondary particle, then adding dispersants, thickeners, or conductive agents at a certain proportion. Furthermore, such cathode active material may be provided in the form of an electrode, by applying such slurry onto a current collector substrate and forming a film. Moreover, the secondary battery of the present invention utilizes the cathode for secondary battery of the present invention, and is provided by constructing a secondary battery along with other constituent materials such as known anodes, separators, and electrolytes.

The particulate mixture of the present invention, which is an active material precursor, is synthesized by a spray combustion method such as the flame hydrolysis method and the thermal oxidation method. Further, the cathode active material of the present invention is synthesized by calcining the particulate mixture, which is an active material precursor.

### (Method for Producing the Particulate Mixture by the Spray Combustion Method)

The spray combustion method is a method for obtaining the substance of object by supplying its component raw material into a flame, by a method of supplying raw material gas such as chlorides or by a method of supplying raw material liquid through a carburetor, along with a combustion-supporting gas and a flammable gas, whereby the component raw materials are reacted. As a spray-combustion method, the VAD (Vapor-phase Axial Deposition) method etc. may be listed as a preferable example. The temperatures of such flames depend on the mixture ratio of the flammable gas and the combustion-supporting gas or the addition ratio of the component raw material, but are normally in the range of 1000 to 3000° C., and are preferably in the range of about 1500 to 2500° C., and more preferably, in the range of about 1500 to 2000° C. When the temperature of the flame is low, the particulate may exit the flame before the reaction is completed in the flame. Further, when the flame temperature is high, the crystallinity of the particulate produced may become excessively high, which may lead to the production of a stable phase, which is not favorable for the cathode active material, in the subsequent calcination process.

Further, the flame hydrolysis method is a method in which the component raw materials undergo hydrolysis in a flame. In the flame hydrolysis method, an oxyhydrogen flame is generally used as the flame. In a flame to which hydrogen gas is supplied as the flammable gas and oxygen gas is supplied as the combustion-supporting gas, component raw materials of the cathode active material and flame raw materials (oxygen gas and hydrogen gas) are supplied simultaneously from a nozzle to synthesize the substance of object. In the flame hydrolysis method, very fine nano-scaled particulates of the substance of object that is mainly amorphous can be obtained under inert gas-filled atmosphere.

Furthermore, the thermal oxidation method is a method wherein the component raw materials undergo thermal oxidation in a flame. In the thermal oxidation method, a hydrocarbon flame is generally used as the flame. In a flame supplied with hydrocarbon gas as the flammable gas and air as the combustion-supporting gas, the component raw materials and the flame materials (for example, propane gas and oxygen gas) are simultaneously supplied from a nozzle, whereby the substance of object is synthesized. Various paraffin-type hydrocarbon gas such as methane, ethane, propane and butane, or olefin-type hydrocarbon gas such as ethylene, propylene, and butylene, may be used as the hydrocarbon gas.

### (Component Raw Materials for Obtaining Particulate Mixture)

The component raw materials for obtaining the particulate mixture of the present invention are a lithium source, a transition metal source, and a phosphorus source. If the raw material is solid, it may be supplied as a powder or may be dispersed in a liquid or dissolved in a solvent and supplied into the flame via a carburetor. If the raw material is liquid, other than passing through a carburetor, it may be vaporized and supplied by heating, depressurizing, or bubbling to increase its vapor pressure prior to the supply nozzle. In particular, it is preferable for a mixed solution of the lithium source, transition metal source, and phosphorus source to be supplied as a mist-like droplet with a diameter of 20 μm or smaller.

As a lithium source, inorganic acid salts of lithium such as lithium chloride, lithium hydroxide, lithium carbonate, lithium nitrate, lithium bromide, lithium phosphate, and lithium sulfate, organic acid salts of lithium such as lithium oxalate, lithium acetate, and lithium naphthenate, lithium alkoxides such as lithium ethoxide, organic lithium compounds such as β-diketonato compound of lithium, lithium oxide, and lithium peroxide, etc. can be used. Note that naphthenic acid is a mixture of different carboxylic acids, in which a plurality of acidic substances in petroleum are mixed, and its main components are carboxylic compounds of cyclopentane and cyclohexane.

As a transition metal source, chlorides of various transition metals such as ferric chloride, manganese chloride, titanium tetrachloride, and vanadium chloride, oxalates of transition metals such as iron oxalate and manganese oxalate, transition metal acetates such as manganese acetate, sulfates of transition metals such as ferrous sulfate and manganese sulfate, nitrates of transition metals such as manganese nitrate, hydroxides of transition metals, such as manganese oxyhydroxide and nickel hydroxide, ethylhexanoates (also known as octylates) of transition metals such as ferric 2-ethylhexanoate and manganous 2-ethylhexanoate, tetra-(2-ethylhexyl)titanate, naphthenates of transition metals such as iron naphthenate, manganese naphthenate, chromium naphthenate, zinc naphthenate, zirconium naphthenate, and cobalt naphthenate, transition metal hexoates such as manganese hexoate, cyclopentadienyl compounds of transition metals, transition metal alkoxides such as titanium tetraisopropoxide (TTIP) and titanium alkoxide, etc. may be utilized. Moreover, organometallic salts of transition metals, i.e. of stearic acid, dimethyldithiocarbamic acid, acetylacetonate, oleic acid, linoleic acid, and linolenic acid etc., and oxides of various transition metals such as iron oxide and manganese oxide, may be utilized depending on conditions.

As described later, to use two or more types of transition metals as the lithium transition metal phosphate compound, two or more types of raw materials of transition metal materials should be supplied into the flame.

As a phosphorus source, phosphoric acids such as phosphonic acid, orthophosphoric acid, and methaphosphoric acid, pyrophosphoric acid, ammonium hydrogen phosphates such as diammonium hydrogen phosphate and ammonium dihydrogen phosphate, various phosphates or pyrophosphates such as ammonium phosphate and sodium phosphate, as well as phosphates of the introduced transition metals such as ferrous phosphate, can be utilized.

Furthermore, when part of the phosphate in the lithium transition metal phosphate compound is substituted by another anion, transition metal oxides and raw materials of boric acid are added as an anion source.

For example, titanium oxide, titanites such as iron titanite and manganese titanite, titanates such as zinc titanate, magnesium titanate and barium titanate, vanadium oxide, ammonium metavanadate, chromium oxide, chromates and dichromates, manganese oxide, permanganates and manganates, cobaltates, zirconium oxide, zirconates, molybdenum oxides, molybdates, tungsten oxide, tungstates, various borates such as boric acid, boron trioxide, sodium metaborate, sodium tetraborate, and borax can be used along with the respective desired anion source according to the synthesis conditions.

These materials are supplied to the same reaction system along with flame materials to synthesize the particulate mixture. The generated particulate mixture can be recovered by a filter from the exhaust. Further, as stated below, it may be produced on the perimeter of a wick stick. By installing a wick stick (also known as a core stick) of silica or a silicon-type material into the reaction vessel, supplying a lithium source, a transition metal source, and a phosphorus source in an oxyhydrogen flame or a propane flame that is sprayed thereto, to thereby perform hydrolysis or oxidization, a particulate of nano-order is generated and collected on the surface of the wick stick. These generated particulates are collected and filtered or sieved as necessary to remove impurities and large condensations. The particulate mixture thus obtained has a very fine particle size of nano-scale, and mainly consists of amorphous particulates.

In the spray-combustion method, which is the method for producing the particulate mixture of the present invention, the particulate mixture produced is amorphous and the size of the particle is small. Further, in the spray-combustion method, quantity synthesis in a short period of time, as compared with conventional hydrothermal synthesis methods and solid phase synthesis methods, is made possible, and a homogeneous particulate mixture can be obtained at low cost.

### (Features of the Particulate Mixture Obtained by the Spray Combustion Method)

The particulate mixture is composed of amorphous particulates consisting mainly of lithium, transition metal, oxides of phosphorus, and lithium transition metal phosphate, but often contains crystalline oxides of transition metals, as well. Further, it may partly contain crystalline components of the lithium transition metal phosphate-type compound. It is preferable that the element spatial distribution within the particles that constitute the particulate mixture is uniform. In particular, it is preferable that there is no deviation in the spatial distribution of the transition metal and phosphorus within the particle. Further, it is preferable that the configuration of the particulate mixture is approximately spherical and that the average aspect ratio (major axis/minor axis) is 1.5 or less, more preferably 1.2 or less, and still more preferably 1.1 or less. Further, the particle size of the particulate mixture is in the range of 5 to 200 nm.

Note that a particle being approximately spherical does not imply that the configuration of the particle is strictly spherical or ellipsoidal in a geometrical sense. The surface of the particle may contain slight protrusions, as long as it is composed mainly of a smooth curved surface.

Measuring the powder X-ray diffraction of such particulate mixture in the range of 2θ=10 to 60° shows almost no peaks, but even if observed, it shows a wide angle of diffraction with a small diffraction peak. These diffraction peaks presumably indicate particulates with small crystallites, polycrystalline particulates formed of aggregated small single crystals, and microcrystallites wherein amorphous components exist around such particulates. The diffractions are thought to be derived from each lithium transition metal phosphate-type compound crystal plane. Note that the position of the peak may shift about ±0.1° to ±0.2° due to distortions of the crystal and measurement errors.

The lithium transition metal phosphate particulate in the particulate mixture obtained, contains lithium transition metal phosphate-type compounds expressed as LiMPO₄. M is at least one transition metal selected from the group consisting of Fe, Mn, Ti, Cr, V, Ni, Co, Cu, Zn, Al, Ge, Zr, Mo, and W. Further, in the spray combustion method of the present invention, carbon is burnt in the flame, and thus, the particulate mixture obtained does not contain carbon. Even if carbon components are included, it would be minimal, and not enough to act as a conductive agent when used as a cathode. Furthermore, the particulate mixture often contains oxides of transition metals. For this reason, a particulate mixture in which iron is used as the transition metal often shows a brownish color due to iron oxide.

### (Method for Producing the Active Material Aggregate)

By calcining the particulate mixture obtained by the spray combustion method under inert gas-filled atmosphere, the active material aggregate is obtained. Further, by calcining, the amorphous compounds and oxide-form mixtures in the particulate mixture and active material change into a crystalline-form compound of olivine structured lithium transition metal phosphate-type. Under inert gas-filled atmosphere, the burning of the carbon source and the oxidation of the cathode active material can be prevented. As the inert gas, nitrogen gas, argon gas, neon gas, helium gas, carbon dioxide gas etc. may be used. In order to enhance the conductivity of the product after heat-treatment, a polyalcohol such as polyvinyl alcohol, a saccharide such as sucrose, or an organic compound that is a conductive-carbon source such as carbon black, is added and mixed with the active material aggregate prior to heat treatment. Polyvinyl alcohol is especially favorable because it also acts as a binder for the particulate mixture and can also reduce the iron component during calcination.

The crystallization of the particulate mixture and the coating or supporting by carbon is performed in the same calcination process. The heat treatment condition is a combination of a temperature of 300 to 900° C. and a treatment time of 0.5 to 10 hours, to obtain a calcined product with the appropriate desired crystallinity and particle size. The heat load of excessively high temperatures and long hours of heat treatment cause the generation of crude large single crystals, and should be avoided. A heat treatment condition that can control the size of the crystallite as small as possible, at a heating condition that provides the desired crystalline or microcrystalline lithium transition metal phosphate compound, is preferable. Note that when the type of transition metal differs, the preferred heat treatment condition differs. For example, when iron is used as the transition metal, heat treatment at 650° C. is preferable, and when manganese is used as the transition metal, heat treatment at 480° C. or 650° C. is preferable. Hence, in general, the heat treatment temperature should preferably be about 400 to 700° C.

### (Method for Producing Cathode Active Material)

The active material aggregate obtained may subsequently be subjected to various pulverization means such as mortar and ball mill to once again prepare a fine particulate. Thus, the cathode active material of the present invention that serves as an intercalation host for Li ion is obtained.

Although most of the crystallized lithium transition metal phosphate-type compounds in the cathode active material of the present invention are fine crystallites, there exists a “microcrystallite” state that partly contain amorphous components. For example, a state wherein particulates constituted of multiple crystallites aggregated together are covered with an amorphous component, or a state wherein fine crystals exist in a matrix of amorphous components, or a state wherein amorphous components exist around and in between particulates, are referred to.

Further, when the cathode active material of the present invention is subjected to transmission electron microscope (TEM) observation to measure the particle diameter, and the particle size distribution is obtained, it exists in the range of 10 to 200 nm, and the average value exist within 25 to 100 nm. These particles are composed of multiple aggregated crystallites. Furthermore, it is preferred that the particle size distribution is in the range of 10 to 150 nm, and that the average value is 25 to 80 nm. Note that the particle size distribution existing in the range of 10 to 200 nm does not necessarily mean that the particle size distribution obtained exist throughout the entire range from 10 to 200 nm, but merely means that the minimum of the particle size distribution is 10 nm or more, and that the maximum is 200 nm or less. That is, the particle size distribution may be 10 to 100 nm, or may be 50 to 150 nm.

In the cathode active material of the present invention, since the particle size is small, the conductive path of Li ion or electrons in the single crystal or polycrystal particle is short. Thus, the ion conductivity and electron conductivity are superior, and they are capable of lowering the barrier of the charge-and-discharge reaction.

In the cathode active material of the present invention, it is preferred that the lithium transition metal phosphate particulate is at least partially carbon-coated or is at least partly supported with carbon. Carbon-coated refers to the coating of the surface of a particle with carbon, and carbon-supported refers to the state of containing carbon within the particle. By carbon-coating or carbon-supporting, the conductivity of the material increases, and a conductive path to the lithium transition metal phosphate particulate is obtained. Thus, the electrode property when using as a cathode is enhanced.

The cathode active material obtained shows different properties in charge-and-discharge capacity etc. depending on the type of transition metal used. For example, when Fe is used as the transition metal, the cost becomes low and synthesis is easy. However, the capacity remains in the conventional level with Fe alone. For the Mn raw material, it is also low in cost and easily synthesized, but there exists a problem in that the crystalline structure of lithium manganese phosphate easily disintegrate with the intercalation and de-intercalation of Li, and its charge-and-discharge cycle life tends to be short. Hence, by using two transition metal elements, as in lithium iron manganese phosphate (LiFe₁₋ₓMnₓPO₄) that utilizes both Fe and Mn, the aforementioned problems of low capacity and crystal structure disintegration can be solved. On the other hand, Fe contributes to the stabilization of the crystalline structure. The same can be said for those other than Fe and Mn, such as Ti, Cr, V, Ni, Co, Cu, Zn, Al, Ge, Zr, Mo, and W.

On the other hand, part of PO₄ can also be substituted with another anion. For example, acids of the aforementioned transition metals, such as titanic acid (TiO₄), chromic acid (CrO₄), vanadic acid (VO₄, V₂O₇), zirconic acid (ZrO₄), molybdic acid (MoO₄, Mo₇O₂₄), tungstic acid (WO₄), etc., and substitution by boric acid (BO₃) may be listed. By substituting part of the phosphate ion with these anions, the change in crystalline structure due to repeated Li dissociation and occlusion can be suppressed, contributing to its stabilization, which enhances the cycle life. Further, since these anions hardly release oxygen even at high temperature, there is little chance of causing ignition, and can thus be used safely.

### (Cathode for Non-aqueous Electrolyte Secondary Battery)

In order to prepare a cathode using the cathode active material obtained by pulverizing the active material aggregate of the heat-treated particulate mixture, to a cathode active material powder coated or supported with carbon is added conductive materials such as carbon black as required, along with binding agents such as polytetrafluoroethylene, polyvinylidene fluoride, and polyimide, dispersants such as butadiene rubber, thickeners such as carboxymethyl cellulose and other cellulose derivatives. This mixture is added to an aqueous solvent or organic solvent to form a slurry, which is then applied on one or both surfaces of a current collector such as aluminum alloy foil that contains 95 wt % or more of aluminum, then evaporated and solidified by calcination. Thus, the cathode of the present invention is obtained.

Here, in order to enhance the applicability of the slurry, the adhesiveness between the current collector and the active material, or the current collectivity, a secondary particle obtained by granulating the aforementioned cathode active material and the carbon source etc. through a spray-dry method and calcining the granulated particle, may be added to the slurry in place of the aforementioned active material. The cluster of the granulated secondary particle becomes a large cluster of about 0.5 to 20 μm, but the applicability of the slurry is enhanced drastically, leading to better battery electrode property and service life. The slurry used in the spray-dry method may either be of aqueous solvent or non-aqueous solvent.

Furthermore, in the cathode formed by applying the slurry containing the cathode active material onto a current collector such as aluminum alloy foil, the surface roughness of the current collector on which the active material is formed is preferably 0.5 μm or more for the ten-point average roughness Rz, specified by the Japanese Industrial Standards (JIS B0601-1994). The adhesiveness of the formed active material layer and the current collector is enhanced, and the electron conductivity accompanying the insertion-and-desorption of Li ion, as well as the current collectivity to the current collector, increases, leading to improved charge-and-discharge cycle life.

Furthermore, if a composite state, in which the main components of the current collector is diffused to at least the active material layer, appears at the interface of the aforementioned current collector and the active material layer formed on the current collector, the binding ability at the interface of the current collector and the active material layer improves, and tolerance against change in volume and crystalline structure with charge-and-discharge cycle increases, thereby improving the cycle life. It is more preferable when the aforementioned surface roughness condition of the current collector is also fulfilled. Under a calcination condition that is sufficient to vaporize the solvent, an interface state with mutual components, wherein the current collector component is diffused to the active material layer, is formed, which shows superior adhesiveness, tolerates volume change due to the entrance and exit of Li ion even after repeated charge-and-discharge, and enhances cycle life.

### (Non-Aqueous Electrolyte Secondary Battery)

In order to obtain a high capacity secondary battery that uses the cathode of the present invention, various materials, such as anodes that utilize known anode active materials, electrolyte solutions, separators, cell casings, etc. can be used without particular restriction.

Although the secondary battery that utilizes the cathode of the present invention shows high capacity and excellent electrode properties, by using or adding a non-aqueous solvent containing fluoride in the non-aqueous electrolyte solution that constitutes the secondary battery, the decrease in capacity by repeated charge-and-discharge can be inhibited, and the service life can be prolonged. For example, in particular, when using an anode that comprises a high capacity silicon-type anode active material, in order to inhibit the large expansion and contraction due to the doping and undoping of Li ion, it is desirable to use an electrolyte solution that contains fluorine, or an electrolyte solution that contains a non-aqueous solvent that has fluorine as a substituent. Since a fluorine-containing solvent reduces the volume expansion of the silicon-type film that is formed by alloying with Li ion during charging, especially in the initial charging treatment, it can inhibit the decline in capacity due to charge-and-discharge. Fluorinated ethylene carbonate and fluorinated linear carbonate, etc. can be used as the fluorine-containing non-aqueous solvent. An example of fluorinated ethylene carbonate is mono-tetra-fluoroethylene carbonate (4-fluoro-1,3-dioxolan-2-one, FEC) and examples of fluorinated linear carbonates are methyl-2,2,2-trifluoroethyl carbonate, ethyl-2,2,2-trifluoroethyl carbonate, etc. These may be added to the electrolyte solution singly or in combination. Since fluorine substituents easily bond with silicon and are tough, it is thought that it stabilizes the film even during expansion due to charge-alloying with Li ion, and contributes to inhibiting expansion.

### Effect of the Present Invention

According to the present invention, using the spray combustion method, lithium transition metal phosphate with a small particle size and uniform element spatial distribution can be synthesized continuously at large scale.

Further, since the lithium transition metal phosphate-type cathode active material of the present invention has a small particle size, the conductive path for Li ion or electron is short, and excellent ion conductivity and electron conductivity are obtained, enabling the active material to be efficiently involved in charge-and-discharge, allowing high-speed charge-and-discharge.

Moreover, in the lithium transition metal phosphate-type cathode active material of the present invention, the element spatial distribution is uniform, and thus, a conductive path for lithium ion can be secured, and active materials that constitute the particle may be used efficiently.

Furthermore, compared to conventional cathode active materials, the cathode active material of the present invention is also characteristic in that it comprises a microcrystallite state, in which amorphous components exist in part of the surroundings of the crystal. Such state is not obtained in the cathode active material by the solid-state reaction method, which has been generally used as the conventional production method. They are obtained by first preparing a mainly-amorphous active material precursor by, for example, supplying raw materials that act as sources for the cathode active material to the same reaction system to react within a flame, and then subjecting the precursor to heat treatment. According to such production method, a porous active material aggregate is easily obtained, and thus, by pulverizing this aggregate to a microscopic size, a uniform cathode active material with small particle size of approximately spherical configuration can be obtained. Thus, it becomes possible to granulate into a secondary particle of a size that is easy to apply on a current collector, and a cathode active material layer, which shows excellent adhesiveness between the current collector and the active material, with the current collector component diffused thereto, can be obtained. Further, since it is a phosphate-type compound that does not discharge oxygen, it does not cause ignition and combustion even at high-temperature environments, and can thus provide a safe secondary battery.

### EXAMPLE

Hereinafter, the present invention will be described in detail with reference to Examples. However, the present invention is not limited to such Examples.

Note that although in the following Examples, lithium iron phosphate compounds were synthesized, when other transition metals are used or other anions are added to the component material, similar synthesis methods can be applied, and products can be provided.

### (1-1) Example 1

### Spray Combustion Method

### (Preparation of the Particulate Mixture)

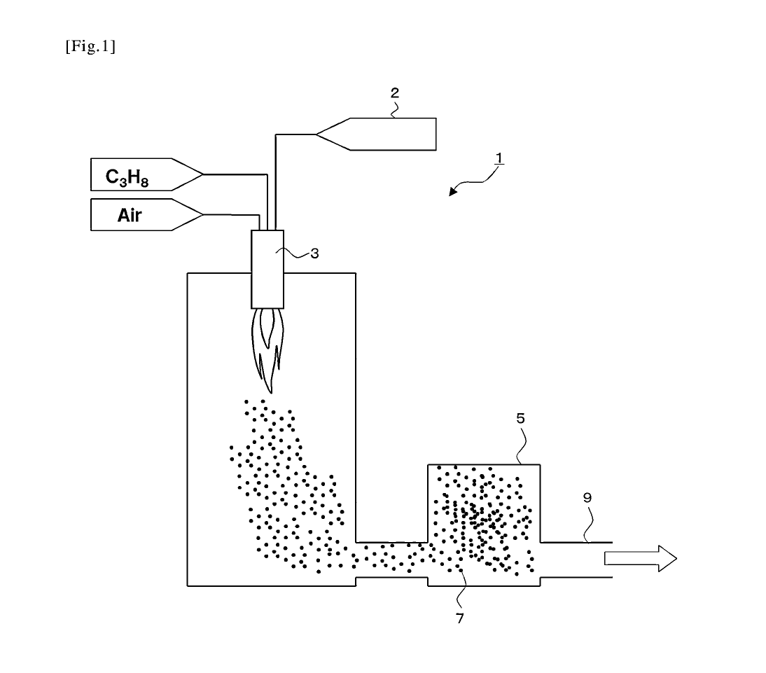

A production apparatus for producing the particulate mixture by the spray combustion method is shown in FIG. 1. In the reaction vessel in the apparatus of FIG. 1, particulate synthesis nozzle 3 is provided within the vessel, and propane gas (C₃H₈), air (Air), and the raw material solution 2 are supplied to the flame that is generated from the nozzle 3. On the other side is an exhaust pipe 9 for evacuating the particulates produced and the reaction product, and the particulate mixture 7 in the exhaust is collected by the particulate collection filter 5. The types of raw material supplied to the nozzle and their supply conditions were set as follows. Further, the raw material solutions were supplied to the flame, using a binary fluid nozzle, so that the sizes of the droplets were 20 μm. The temperature of the flame was about 2000° C.

propane (C₃H₈): 1 dm³/min,

air: 5 dm³/min,

lithium naphthenate (4 M solution): 0.025 dm³/min

C₁₆H₃₀FeO₄ (iron(II)₂-ethylhexylate) (1 M solution): 0.1 dm³/min

triethyl phosphonoacetate (1M solution): 0.1 dm³/min

The production method of the particulate mixture by the spray combustion method is as follows. First, a specified amount of N₂ gas was supplied so that the interior of the reaction vessel became an inert atmosphere. Under such conditions, a mixed solution of the lithium source, iron source, and phosphate source, was made into droplets of 20 μm by passing through an atomizer, and supplied to the flame along with propane gas and air. The particulate mixtures containing particulates of lithium oxide, iron oxide, and phosphorus oxide etc., as well as particulates of lithium iron phosphate compounds, were collected by the particulate collection filter. The particulate mixture obtained was particulate mixture a.

### (Production of the Cathode Active Material)

Next, polyvinyl alcohol was added to particulate mixture a at an amount of 10 wt % and mixed, and subjected to calcining by heat treatment in a N₂ gas-filled air-tight container for 4 hours at 650° C. Carbon coating or carbon supporting was performed during calcination, and an active material aggregate was obtained. This active material aggregate was subjected to pulverization treatment to obtain cathode active material A.

### (1-2) Example 2

### Spray Combustion Method

### (Preparation of the Particulate Mixture)

Further, as described in Example 1, particulate mixture b was synthesized by the spray combustion method by supplying a raw material solution of the following specific concentration into a flame of propane gas, along with propane gas and air, and subjecting to thermal oxidation, then collected.

propane (C₃H₈): 1 dm³/min,

air: 5 dm³/min,

LiCl (4 M solution): 0.025 dm³/min

FeCl₂.4H₂O (1 M solution): 0.1 dm³/min

triethyl phosphonoacetate (1M solution): 0.1 dm³/min

### (Production of the Cathode Active Material)

Particulate mixture b was treated as described in Example 1 to obtain an active material aggregate. This active material aggregate was subjected to pulverization treatment to obtain cathode active material B. From the results of the later-described XRD and transmission electron microscope, cathode active material B of Example 2 was found to be particles similar to those of cathode active material A of Example 1.

### (1-3) Example 3

### Spray Combustion Method

### (Preparation of the Particulate Mixture)

Further, as described in Example 1, particulate mixture c was synthesized by the spray combustion method by supplying a raw material solution of the following specific concentration into a flame of propane gas, along with propane gas and air, and subjecting to thermal oxidation, then collected.

propane (C₃H₈): 1 dm³/min,

air: 5 dm³/min,

LiCl (4 M solution): 0.025 dm³/min

MnSO₄.5H₂O (1 M solution): 0.1 dm³/min

triethyl phosphonoacetate (1M solution): 0.1 dm³/min

### (Production of the Cathode Active Material)

Particulate mixture c was treated as described in Example 1 to obtain an active material aggregate. This active material aggregate was subjected to pulverization treatment to obtain cathode active material C. From the results of the later-described XRD and transmission electron microscope, cathode active material C of Example 3 was found to be particles similar to those of cathode active material A of Example 1.

### (2) Comparative Example 1

### Solid Phase Method

Further, active material s was prepared. In an electric furnace, the following raw materials were mixed and injected, then calcined to perform synthesis by the solid phase method.

iron oxalate (FeC₂O₄.2H₂O): 0.1 mol,

lithium dihydrogen phosphate (LiH₂PO₄): 0.1 mol,

After pre-calcination under nitrogen atmosphere at 700° C. for 12 hours, actual calcination under nitrogen atmosphere at 1000° C. for 24 hours was repeated twice, to obtain active material s by the solid phase method.

To this active material s, the calcination process of Example 1 was performed to obtain cathode active material S.

### (3) Measurement and Observation of the Samples

### (3-1) Powder X-ray Diffraction Measurement

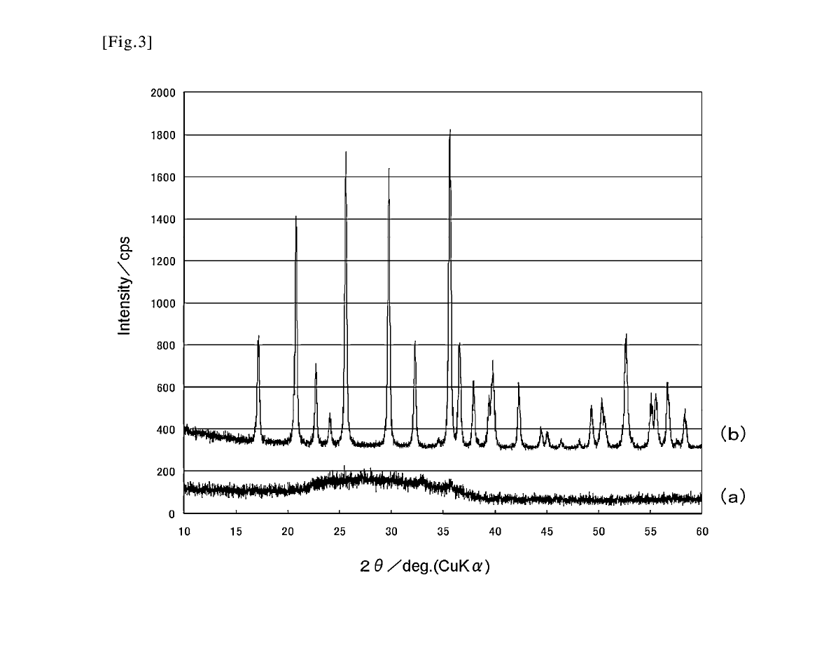

The particulate mixture and cathode active material of Example 1 were subjected to powder X-ray diffraction measurement (2θ=10 to 60°). The X-ray diffraction measurement results are shown in FIG. 3.

As shown in FIG. 3(a), the particulate mixture prior to calcination, which is an active material precursor, did not show a peak. However, as shown in FIG. 3(b), the cathode active material after calcination showed a multitude of peaks, which were derived from the crystalline structure of lithium iron phosphate.

### (3-2) Transmission Electron Microscope (TEM) Observation

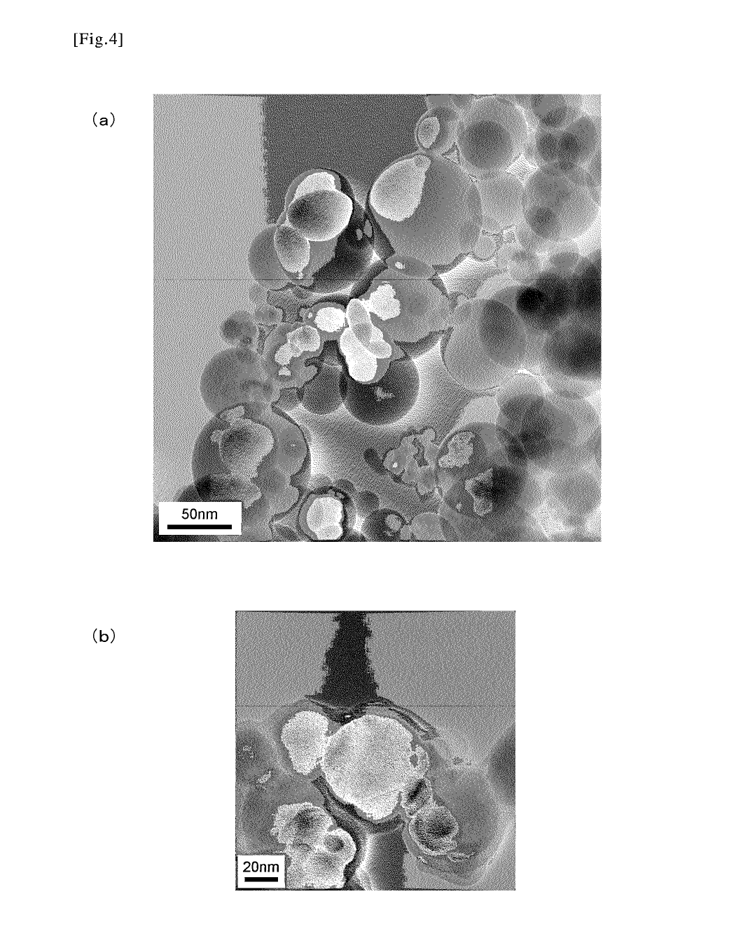

The particulate mixture and cathode active material of Example 1 were subjected to observation by TEM. The TEM image observation results are shown in FIG. 4.

As shown in FIG. 4(a), the configuration of the particulate mixture prior to calcination was spherical, and particles with a diameter of 5 to 100 nm were observed. Further, the average aspect ratio (major axis/minor axis) for these particles was 1.1 or less. Furthermore, as shown in FIG. 4(b), the configuration of the cathode active material after calcination was also spherical, with a primary particle size of 20 to 100 nm. Amorphous carbon was coated around the spherical lithium iron phosphate particles. Further, in FIG. 4, since no deviations were observed in the transmittance of the particulate mixture and the cathode active material, it is thought that these particles have uniform compositions within the particles.

### (3-3) Composition Analysis by EDS

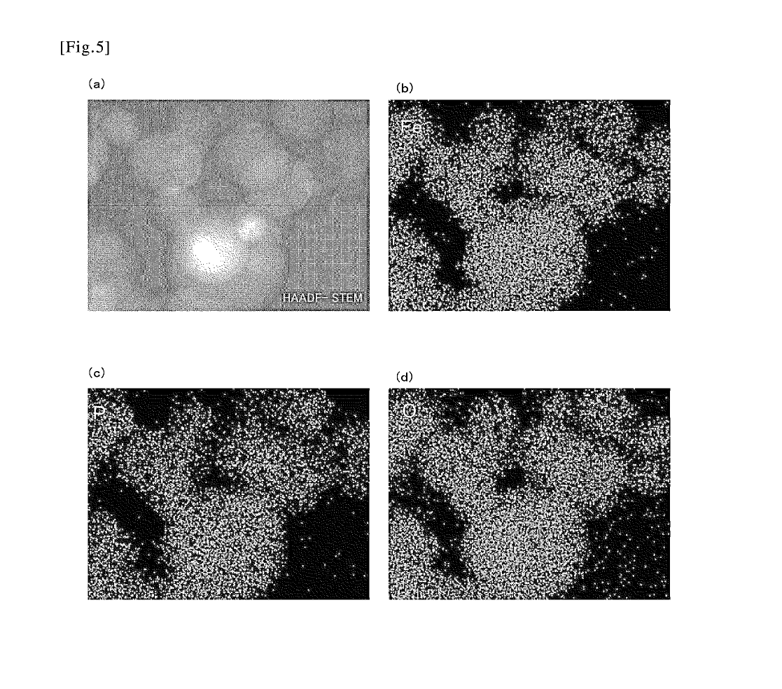

The particle configuration observation and composition analysis for the particulate mixture of Example 1 were performed. The particle configuration was observed by HAADF-STEM (High-Angle-Annular-Dark-Field-Scanning-Transmission-Electron-Microscopy) and the composition was analyzed by EDS (Energy Dispersive Spectroscopy) analysis using a scanning transmission electron microscope (JEM 3100FEF, by JEOL Ltd.). FIG. 5(a) shows the HAADF-STEM image of the particulate mixture of Example 1, FIG. 5(b) is the EDS map for iron atom from the same observation point, FIG. 5(c) is the EDS map for phosphorus atom from the same observation point, and FIG. 5(d) is the EDS map for oxygen atom from the same observation point.

In FIG. 5(a), since the contrast within the particle was uniform, it was proven that the composition within the particle was uniform. Furthermore, in FIG. 5(b) to (d), since the atom distribution of oxygen, iron and phosphorus coincided, it was proven that the composition within the particle was uniform and had no deviations. Also, it was found that there were no deviation in composition among the particles, and were uniform, too.

### (4) Preparation of the Cathode for Test Evaluation using Active Material Samples, and Secondary Battery

To cathode active materials A (spray combustion method) and S (solid phase method) obtained in the Example and Comparative Example, conductive agents (carbon black) were added so that the amount became 10 wt %, and further mixed for 5 hours in a ball mill with its interior substituted by nitrogen. The mixed powder and polyvinylidene fluoride (PVdF), which is a binding agent, were mixed at a weight ratio of 95:5. N-methyl-pyrrolidone (NMP) was added and kneaded thoroughly, to obtain the cathode slurry.

The cathode slurry was applied to an aluminum foil current collector with a thickness of 15 μm at an application amount of 50 g/m², and dried for 30 minutes at 120° C. Subsequently, it was subjected to strip processing by a roll press so that its density became 2.0 g/cm³, and a disk of 2 cm² was punched out, to thereby obtain a cathode.

The cathodes, along with an anode of metal lithium, and an electrolyte solution of 1 M of LiPF₆ dissolved in a mixed solvent of ethylene carbonate and diethyl carbonate at a volumetric ratio of 1:1, were used to prepare a lithium secondary battery. Note that the preparation environment was set to a dew point of −50° C. or under. The electrodes were pressure bonded to a battery case with current collectors and used. Using the above cathode, anode, electrolyte and separator, a coin-type lithium secondary battery with a diameter of 25 mm and a thickness of 1.6 mm was prepared.

### (5) Test Evaluation of the Samples

Next, using the above coin-type lithium secondary battery, the cathode active material of the present invention was subjected to test evaluation as follows.

At a test temperature of 25° C., charging was performed up to 4.2 V (against Li/Li⁺) at a current rate of 0.1 C by the CC-CV method, and charging was terminated when the current rate decreased to 0.005 C. Subsequently, at a current rate of 0.1 C, discharge was performed by the CC method until the voltage became 2.0 V (same as above), and the initial discharge capacity was measured.

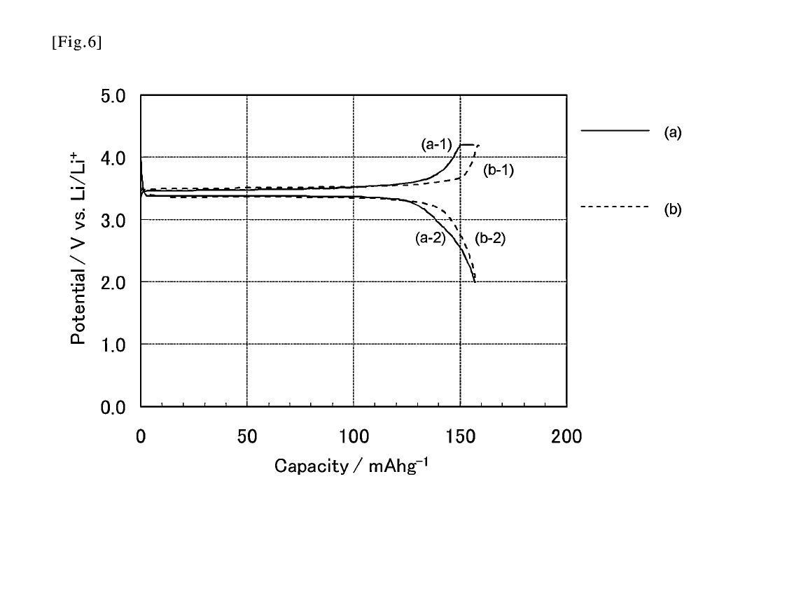

The initial charge-and-discharge curves for the lithium ion secondary battery using cathode active material A prepared by the spray combustion method of Example 1 (solid line), and the initial charge-and-discharge curves for the lithium ion secondary battery using cathode active material S prepared by the solid phase method of Comparative Example 1 (dotted line) are shown in FIG. 6. In FIGS. 6, (a-1) and (b-1) each show the charge curve and (a-2) and (b-2) each show the discharge curve. The value of the abscissa at the right end of the discharge curve is the discharge capacity. According to FIG. 6, both Example 1 and Comparative Example 1 show a discharge capacity of about 160 mAh/g. This result proves that Example 1 shows a discharge capacity that is equivalent to that of Comparative Example 1, which utilizes the conventional solid phase method.

As described above, the cathode obtained by applying the cathode active material of the present invention on a specified current collector can be used as a cathode that shows superior charge-and-discharge properties in various chargeable and dischargeable secondary batteries such as lithium ion secondary batteries that utilize non-aqueous electrolytes. By further improvements, the compound group of the present invention can become the foundation for enhancing the charge-and-discharge behavior even more, with higher theoretical specific capacity inherent to such compounds in view. Thus, properties of higher energy or higher output, not available conventionally, can be added to applications in conventional electronic equipments, as well as in industrial and automotive applications that are being put into practical use. Moreover, the spray combustion method, which is the production method for the particulate mixture of the present invention, is excellent in mass productivity, and is capable of providing products at low cost.

Note that although iron was used as the transition metal in the above-described Example, the present invention is characteristic in that a particulate mixture of nano-size, which is the active material precursor, is obtained by the spray combustion method, and that the cathode active material is obtained by calcining such particulate mixture. Thus, even when transition metal elements other than iron are used, cathode active materials can be expected by similar means. That is, it is obvious that a similar particulate mixture of nano-size can be obtained even when transition metals other than iron is used, as long as the particulate mixture is obtained in a short period of time (several milliseconds) at high temperature (about 2000° C.) using the spray combustion method. It is apparent that a powder of crystalline cathode active material with an olivine-type crystalline structure can be obtained by calcining such particulate mixture.

As described in detail above, suitable embodiments of the present invention were described with reference to the accompanying figures. However, the present invention is not limited to such examples. It should be understood by those in the field that examples of various changes and modifications are included within the realm of the technical idea of the present invention, and that such examples should obviously be included in the technical scope of the present invention.

### DESCRIPTION OF NOTATIONS

1 Particulate Production Apparatus
2 Raw Material Solution
3 Particulate Synthesis Nozzle
5 Particulate Collection Filter
7 Particulate Mixture
9 Exhaust Pipe
11 Non-aqueous Electrolyte Secondary Battery
13 Cathode
15 Anode
17 Separator
19 Electrolyte
21 Battery Case
23 Cathode Lead
25 Anode Lead
27 Cathode Terminal
29 Sealing Material

1. A method for producing a particulate mixture, which comprises: supplying a mist-like droplet of a mixed solution containing a lithium source, a transition metal source, and a phosphorus source into a flame along with a combustion-supporting gas and a flammable gas to thereby synthesize a particulate mixture.

2. The method for producing a particulate mixture according to claim 1, wherein a temperature of the flame is 1000 to 3000° C.

3. The method for producing a particulate mixture according to claim 1, wherein
the flammable gas is a hydrocarbon-type gas, and
the combustion-supporting gas is air.

4. The method for producing a particulate mixture according to claim 1, wherein
a lithium compound of the lithium source is one or more of lithium chloride, lithium hydroxide, lithium acetate, lithium nitrate, lithium bromide, lithium phosphate, lithium sulfate, lithium oxalate, lithium naphthenate, lithium ethoxide, lithium oxide, and lithium peroxide;
a transition metal compound of the transition metal source is one or more of a chloride, oxalate, acetate, sulfate, nitrate, hydroxide, ethyl hexanoate, naphthenate, salt of hexoate, cyclopentadienyl compound, alkoxide, organic acid metal salt (salts of stearic acid, dimethyl dithiocarbamic acid, acetyl acetonate, oleaic acid, linoleic acid, linolenic acid), or oxide of at least one transition metal selected from a group consisting of Fe, Mn, Ti, Cr, V, Ni, Co, Cu, Zn, Al, Ge, Zr, Mo, and W; and
a phosphorus compound of the phosphorus source is one or more of phosphonic acid, orthophosphoric acid, methaphosphoric acid, pyrophosphoric acid, diammonium hydrogen phosphate, ammonium dihydrogen phosphate, ammonium phosphate, sodium phosphate, and ferrous phosphate.

5. A method for producing a lithium transition metal phosphate-type cathode active material, which comprises:
a process of mixing the particulate mixture produced by the method of producing a particulate mixture according to claim 1 with a carbon source; and
a process of calcining the particulate mixture mixed with the carbon source under inert gas atmosphere to thereby produce an active material aggregate.

6. The method for producing a lithium transition metal phosphate-type cathode active material according to claim 5, which further comprises a process of pulverizing the active material aggregate.

7. The method for producing a cathode active material according to claim 5, wherein the carbon source is one or more of poly vinyl alcohol, sucrose, and carbon black.

8. The method for producing a cathode active material according to claim 5, wherein the calcining is performed by heat treatment under inert gas atmosphere for 0.5 to 10 hours at 300 to 900° C.

9. A method for producing a cathode for non-aqueous electrolyte secondary battery, which comprises:
a process of mixing a cathode active material produced by the method for producing a cathode active material according to claim 5 with at least a binding agent and a solvent to thereby prepare a slurry; and
a process of applying the slurry on to a current collector and calcining.

10. The method for producing a cathode for non-aqueous electrolyte secondary battery according to claim 9, wherein the slurry contains a secondary particle with a size of 0.5 to 20 μm obtained by granulating the cathode active material produced by the method for producing a cathode active material according to claim 5.

11. A particulate mixture, in which the configuration of a primary particle is approximately spherical;
a particle size of the primary particle is in a range of 5 nm to 200 nm; and
which comprises a particle containing phosphorus, transition metal, and lithium.

12. The particulate mixture according to claim 11, wherein
the particulate is amorphous; and
the particulate contains an oxide of the transition metal.

13. The particulate mixture according to claim 11, wherein an element spatial distribution within the particulate is uniform.

14. A cathode active material, which is obtained by calcining the particulate mixture according to claim 11, wherein
the configuration of the primary particle is approximately spherical;
the particle size of the primary particle is in a range of 10 nm to 200 nm; and
which contains a lithium transition metal phosphate particulate.

15. The cathode active material according to claim 14, wherein the lithium transition metal phosphate particulate is at least partly carbon-coated or at least partly carbon-supported.

16. The cathode active material according to claim 14, wherein the transition metal in the lithium transition metal phosphate contains at least one element of Fe, Mn, Ti, Cr, V, Ni, Co, Cu, Zn, Al, Ge, Zr, Mo, and W.

17. A cathode for non-aqueous electrolyte secondary battery, which comprises:
a current collector, and
a cathode active material layer containing the cathode active material according to claim 14 on at least one side of the current collector.

18. A non-aqueous electrolyte secondary battery, which comprises:
the cathode for non-aqueous electrolyte secondary battery according to claim 17;
an anode that is able to occlude and discharge lithium ion; and
a separator arranged between the cathode and the anode, wherein
the cathode, the anode and the separator are provided in an electrolyte that shows lithium ion conductivity.
